(19) United States
(12) Patent Application Publication
(10) Pub. No.: US 2018/0206648 A1
(43) Pub. Date: Jul. 26, 2018

(54) Support Pillow for Prone Position

(71) Applicant: Bernadette Virissimo, San Diego, CA (US)

(72) Inventor: Bernadette Virissimo, San Diego, CA (US)

(21) Appl. No.: 15/877,323

(22) Filed: Jan. 22, 2018

Related U.S. Application Data
(60) Provisional application No. 62/449,300, filed on Jan. 23, 2017.

(51) Int. Cl. A47C 20/02; A47G 9/10

(52) U.S. Cl. CPC A47C 20/026; A61G 13/121; A47G 9/1054

(57) ABSTRACT

A support pillow provides a central section and two adjustable side sections allowing for comfortable use by female users while in the prone position, such as during a massage, acupuncture, or other medical procedure. The central section provides comfortable support for the head and neck, while the side sections are positionable under the user to relieve pressure on the breasts and chest area. A tether between the side sections allows them to be held in place while the support pillow is in use.

### RELATED APPLICATION

This application claims the benefit of priority to the United States Provisional Patent Application for “Support Pillow for Prone Position,” Ser. No. 62/449,300 filed on Jan. 23, 2017, and currently co-pending.

### FIELD OF THE INVENTION

The present invention relates generally to pillows. More particularly, the invention relates to a pillow configured to provide adjustable comfortable support for a user positioned in the prone position. The pillow is especially well adapted for comfortable support of female users while in the prone position such as during a massage.

### BACKGROUND

People have enjoyed the receipt of massages for many hundreds of years. During a massage session frequently the therapist will have the massage recipient or client, lie in a prone position upon the massage table. With the client in such a face-down positioning, the massage therapist is able to impart massage therapy to various areas of the back of the body of the client.

While the massage itself is generally comforting and therapeutic to the client receiving it, being in a prone position upon a massage table for long periods of time, can cause significant discomfort. This is especially true for female massage recipients because of the differing anatomical characteristics of the female body.

In addition to massage therapy, other procedures may require a patient to remain prone for a period of time. For example, acupuncture, physical therapy, radiation treatment, or other medical procedures sometimes involve a patient lying in a face-down position.

For females who lie in such a prone position upon the abdomen, the position on the table creates pressure on the breasts. This pressure causes significant discomfort which increases over the time duration in the prone position, and can be a significant impediment to the enjoyment of a massage. The relative discomfort level can be significantly increased where the female has breast implants, or has larger natural breasts, both of which increase the pressure exerted by contact with the table during positioning in a prone position. Still further, lying in a prone position for a duration of time, can also impart discomfort to the neck due to inadequate support placing pressure on the face and chin.

As such, there exists a continuing unmet need for a pillow which is configured to be user-adjustable during use while in the prone position. Such a pillow should be configured to provide comfortable neck and head support. Such a pillow should in addition to a neck support area, provide user adjustable side sections which are positionable by the user under their person while prone, to relieve pressure upon the breasts and chest area. Such a pillow should be easily adjustable to provide such support to users with wide variations in anatomy, to allow positioning in a prone position for a desired duration of time for a massage or even for a medical procedure requiring prone positioning.

The forgoing examples of related art as to pillows offering support while in a prone position and the limitations related therewith, are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The adjustable pillow device herein disclosed and described provides a solution to the shortcomings in prior art with regard to supporting users in a prone position, especially those who are female. The pillow device herein features a central section which is configured in a circular or oval configuration, adapted to provide comfortable support underneath the neck of a prone user.

This central section of the pillow is formed to this oval or circular configuration through the provision of a covering configured to maintain this general shape when the internal filling is compressed between the table surface the neck of the user. The filling may be conventional pillow stuffing or down or feathers or synthetic material. Particularly preferred in this central section is a filling which will adapt to the exterior shape and contours of the neck and chin of the user, but which will not overly compress after a duration of time. A particularly preferred filling for this central section would be a memory foam, or a viscoelastic foam material of a density adapted for comfort but support. Gel infused or gel memory foams are also particular preferred for this central section filling since they adapt to the shape of the head and neck, but do not overly compress over a long duration of time.

The pillow device herein additionally includes a pair of side sections, each of which is pivotally engaged with opposing sides of the central section. Such a pivoting engagement in a preferred mode of the device, is enabled using the fabric covering for the side sections which have a connection at a respective first end, to the central section. This connection may be provided by sewing the covering of the side sections to the ends of the central section, or mechanical or other cooperative connectors engaging the side sections to the opposing ends of the central section.

At respective second ends of each of the side sections, opposite the first ends connected to the central section, is connected opposite ends of an adjustment tether. While both side sections might be pivoted in their respective connection to the central section, and held in position in a sandwiched engagement between the body of the user and the underlying table, it is preferable to provide the adjustment tether. This adjustment tether is configured to allow the user to lengthen or shorten the tether, and thereby position the second ends of both side sections further or closer together.

Both side sections have an exterior covering which forms an internal cavity in which a compressible pillow material is held. The exterior covering may be made of cotton, vinyl, or any other material that is comfortable in contact with the user and appropriate for holding the compressible pillow material being used. The compressible material for each side section may be one or a combination of compressible materials from a group including memory foam, batting, feathers, down, synthetic pillow stuffing, synthetic beads, beans, buckwheat, or other compressible and comfortable pillow stuffing materials. One embodiment provides an inflatable pillow wherein the exterior covering is an air-impermeable material and the compressible material is air.

To many consumers, ease of cleaning the pillow is very important. Preferred embodiments therefore use materials which are washable by modern methods, such as home or industrial washing machines.

In use, the user may position the central section underneath their neck while in a prone position. Subsequently the user may use their arms to pivot both side sections in their engagement to the central section, and draw both side sections to positions underneath the body of the user. The user would pull the side sections to desired positions, sandwiched in-between the body of the user and the underlying support surface, such that pressure is taken off the upper chest and breast area. Once in these desired locations, based on individual user comfort, the user may simply use their weight to hold the side sections in position.

However, in a more preferred mode of the pillow device herein, the adjustable tether is provided. In this mode of the device, once the user locates both of the side sections to their desired locations, they may reach down and adjust the length of the tether such that the tether will maintain the respective angled position of each side section, relative to the axis running through the central section. This is preferred as it allows the pillow to maintain the user selected desired locations of each side section, should the user be asked to lift their body slightly from the prone position.

The exterior covering of both the side sections and the central section, is preferably a soft material which is comfortable in contact with the person of the user over long time durations. For example a terrycloth material or a cotton material similar to that of conventional sheets would provide a breathable and comfortable covering. In inflatable embodiments, vinyl or another air-impermeable material is used. Of course the covering itself may be covered by an overlying pillow case or the like, where the pillow device herein may be used by multiple users in sequence, such as at a spa.

With respect to the above description, before explaining at least one preferred embodiment of the herein disclosed pillow support invention in detail, it is to be understood that the disclosed support pillow is not limited in its application to the details of construction and to the arrangement of the components in the following description or illustrated in the drawings. The support pillow invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other support pillow structures, methods and systems for carrying out the several purposes of the present disclose system and method. It is important, therefore, that the claims be regarded as including such equivalent construction and methodology insofar as they do not depart from the spirit and scope of the present invention. The objects features, and advantages of the disclosed pillow support invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 shows a side plan view of the support pillow for prone users showing two side sections pivotally connected to opposing ends of a central section of the pillow.

FIG. 2a depicts a sectional view along line 2-2 of figure one showing a circular configuration of the body of the central section.

FIG. 2b depicts another sectional view along line 2-2 of figure one showing an oval configuration of the body of the central section.

FIG. 3 depicts the pillow device as in FIG. 1, showing the two side sections pivoting at first ends in their engagement to the central section, and showing the tether adjusted for length to hold the side sections in this angled positioning relative to the axis of the central section.

FIG. 4 depicts the device of FIGS. 1-3 in an as-used positioning, underneath and supporting body of a prone patient on a support surface.

FIG. 5 shows a perspective view of an alternative embodiment of the support pillow for prone users wherein the side sections are integral with the central section;

FIG. 6 shows a side plan view of the alternative embodiment of the support pillow for prone users of FIG. 5;

FIG. 7 depicts the pillow device as in FIG. 5, showing the tether adjusted for length to show the side sections at an angled positioning relative to the axis of the central section; and

FIG. 8 depicts the pillow device as in FIG. 5, showing an alternate tether mechanism wherein two separate lengths of tether are provided and may be tied together at the desired tether length.

Other aspects of the present invention shall be more readily understood when considered in conjunction with the accompanying drawings, and the following detailed description, neither of which should be considered limiting.

### DETAILED DESCRIPTION

In this description, the directional prepositions of up, upwardly, down, downwardly, front, back, top, upper, bottom, lower, left, right and other such terms refer to the device as it is oriented and appears in the drawings and are used for convenience only, they are not intended to be limiting or to imply that the device has to be used or positioned in any particular orientation.

Now referring to drawings in FIGS. 1-4, wherein similar components are identified by like reference numerals, there can be seen in FIG. 1, the device 10 herein, in a side plan view. As shown, the device 10 includes a central section 12 having two ends, and a pair of side sections 14, each of which is connected at a respective first end, to one end of the central section 12.

As noted, the central section 12 of the device 10 is preferably configured in a circular or oval circumference. This oval or circular shape has shown, during experimentation, to provide a more comfortable support underneath the neck of a prone positioned user. Formation of the central section 12 to this oval or circular configuration is accomplished by employment of a covering 16 of fabric or material which is pre-configured to maintain this general shape, once the filling 18 housed within the covering 16 of the central section 12, is compressed between the table surface of the neck of the user.

The filling 18 used in the central section 12, may be conventional pillow stuffing or down or feathers or synthetic material. Particularly preferred however, for the filling 18 in this central section 12 is a memory foam, or a viscoelastic foam, or gel memory foam material of a density adapted for comfort but support, since such material holds a shape for support. Alternatively, the central section 12 may be made of an air-impermeable material such as vinyl and filled with air.

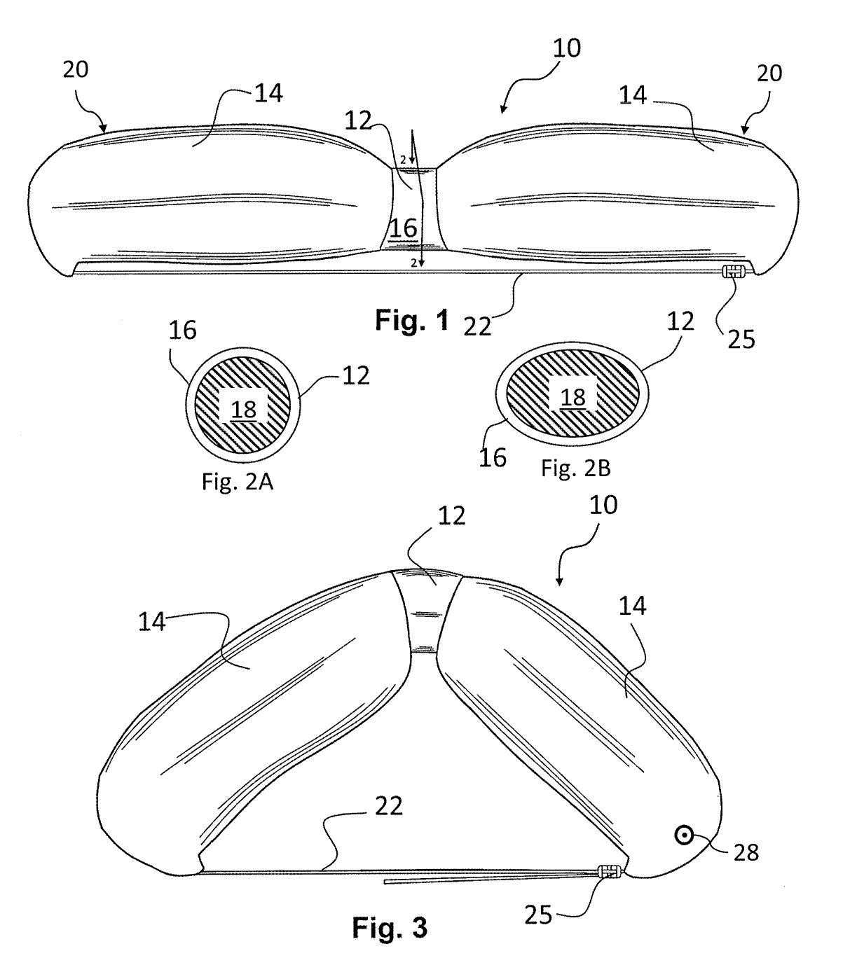

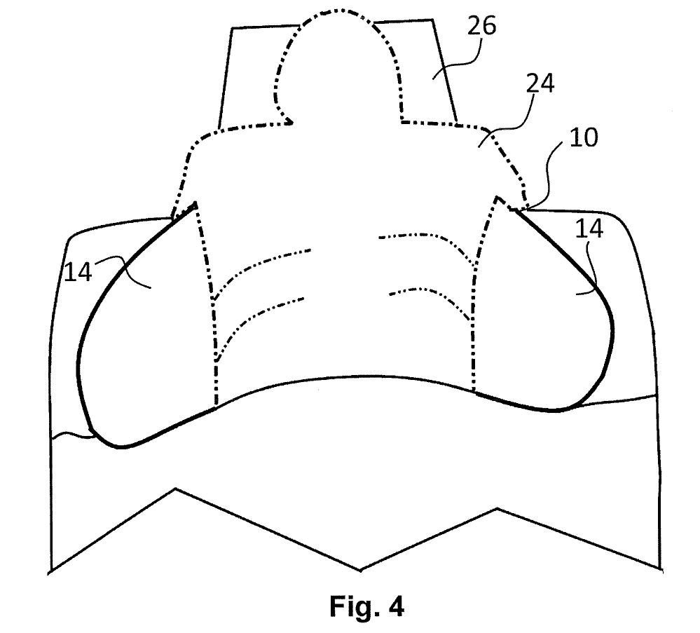

As shown in FIG. 2a, which is a sectional view along line 2-2 of FIG. 1, the filling 18 is held inside the cover 16 of the central section 12, and the covering 12 and the shape of the filling 18 if foam or gel, can act to maintain this shape. The same is true of the sectional view of FIG. 2b. As shown in FIG. 3, the pillow device 10 has two side sections 14. A first end of each respective side section 14, is pivotally connected to one end of the central section 12, in a manner allowing the side sections 14 to angle toward each other when adjusted by a user to desired positions for use such as shown in the as-used positioning of the device 10 shown in FIG. 4.

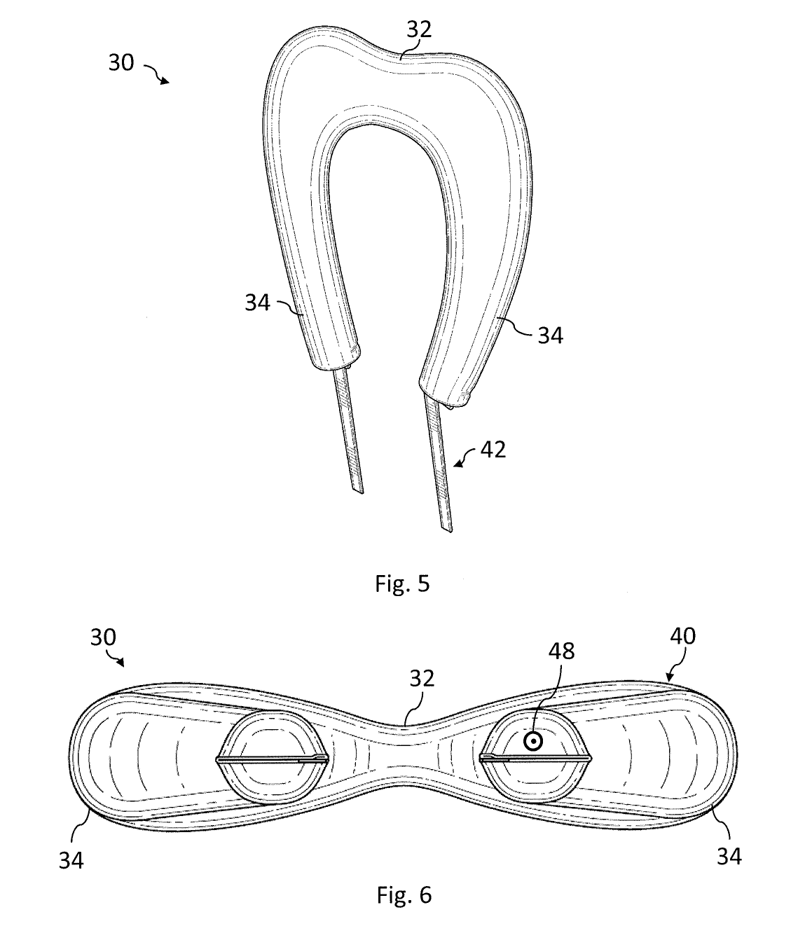

Both side sections 14 have an exterior covering 20 which is sewn or otherwise constructed to form an internal cavity in which a compressible pillow material is held within the side sections 14. In some embodiments, the exterior coverings 20 of the side sections are integral with the covering 16 of the central section, forming a single covering for the pillow device 10. One such embodiment is described more fully below in FIGS. 5-7.

As noted, both side sections 14 are pivotable in their respective connection to the central section 12, when moving to the as-used position selected by the user. While the side sections 14 might be held in the as-used position by the weight of the user, it is preferable to include the adjustment tether 22 which is adjustable in length and engaged at or adjacent the second ends of each of the two side sections 14. Adjustment of the tether length 22 will hold the two side sections 14 in their desired angled positions relative to the axis of the central section 12. The length may be adjusted by simply tying portions of the tether 22 to achieve the desired length, or an adjuster 25 may be provided such as a buckle, a frictional connector, a hook and loop connector such as is sold under the VELCRO® brand, or a drawstring cord lock providing a spring loaded clamp, which will allow a pulling of the tether 22 therethrough, and which will hold and maintain the length of the tether 22 for the duration of use.

Also shown in FIG. 3 is an optional air fill port 28, which is used with inflatable variants of the present invention in which the filling 18 is air.

Finally, shown in FIG. 4, is the device 10 of FIGS. 1 and 3, positioned to an as-used positioning, underneath and supporting body of a prone user 24 who is lying on a support surface 26 such as a massage table. As shown, the two side sections 14 have been pivoted in their respective engagement to the central section 12 which is positioned underneath the neck of the user. The side sections 14 have been drawn inward toward each other to positions underneath the user 24 which support their body in a manner determined by the user 24 to relieve the pressure normally imparted to the chest area when lying prone.

Referring now to FIG. 5, a perspective view of an alternative embodiment of the pillow device is shown and generally designated 30. Pillow device 30 has a tether 42 attached to a unified body described more fully below.

As shown in FIG. 6, the pillow device 30 comprises a unified body having a central section 32 and two side sections 34, in which the central section 32 is integral with the two side sections 34 and defined by a narrowing of the pillow between the side sections 34. The pillow itself is defined by an exterior covering 40 forming a horseshoe shape comprising the two side sections 34 connected by a narrow neck herein referred to as the central section 32. The exterior covering encloses a filling 18 (shown in FIGS. 2A and 2B).

The filling 18 used in the pillow device 30, may be conventional pillow stuffing or down or feathers or synthetic material. Particularly preferred however, for the filling 18 in pillow device 30 is a memory foam, or a viscoelastic foam, or gel memory foam material of a density adapted for comfort but support, since such material holds a shape for support. Alternatively, the pillow device 30 may be made of an air-impermeable material such as vinyl and filled with air. When the pillow device 30 uses air as the filling 18, it may be inflatable and deflatable via an air fill port 48. However, air fill port 48 need not be present if the pillow device 30 uses materials other than air as the filling 18, or if the pillow device 30 is otherwise not user inflatable.

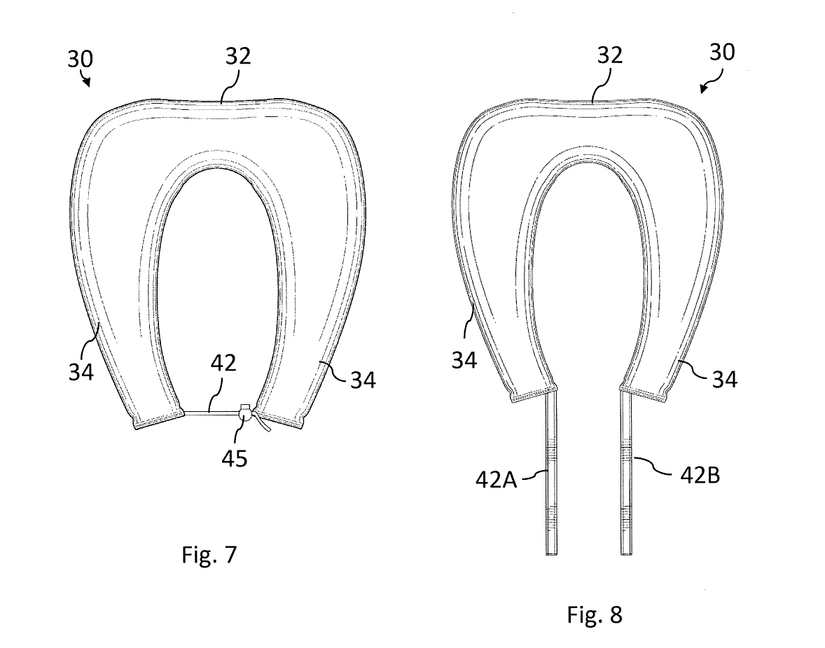

As shown in FIG. 7, a tether 42 aids in holding the side sections 34 in place. As with other embodiments, the side sections 34 may be adjusted to a desired angle with the central section 32 for the user's comfort. While the side sections 34 might be held in the as-used position by the weight of the user, it is preferable to include the adjustment tether 42 which is adjustable in length and engaged at or adjacent the second ends of each of the two side sections 34. Adjustment of the tether length 42 will hold the two side sections 34 in their desired angled positions relative to the axis of the central section 32. An adjuster 45 may be provided such as a buckle, a frictional connector, a hook and loop connector such as is sold under the VELCRO® brand, or a drawstring cord lock providing a spring loaded clamp, which will allow a pulling of the tether 42 therethrough, and which will hold and maintain the length of the tether 42 for the duration of use.

Referring now to FIG. 8, the pillow device 30 may include a tether 42 formed with a two lengths of cord, a first cord 42A and a second cord 42B, instead of an adjuster 45. One length of cord of the tether 42 is attached to each of the two side sections 34. The two cords 42A and 42B are tied together at the desired tether length in order to achieve the desired angled positions of the two side sections 34 relative to the axis of the central section 32. The alternate tether 42 made of a first cord 42A and a second cord 42B without the use of an adjuster may also be used with the embodiment shown in FIGS. 1-4.

It should be noted and anticipated that although the support pillow device 10 for prone users 24 herein is shown in its most simple form, various components and aspects of the device may be differently shaped or slightly modified when forming the invention herein. As such, those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the support pillow invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

While there have been shown what are presently considered to be preferred embodiments of the present invention, it will be apparent to those skilled in the art that various changes, combinations, and modifications can be made herein without departing from the scope and spirit of the invention. Thus the scope of the invention should not be limited according to these factors, but according to the following claims.

What is claimed is:

1. A support pillow, comprising:
a central section having a first end and a second end;
a first side section having a first end and a second end, said first end of said first side section pivotably connected to said first end of said central section; and
a second side section having a first end and a second end, said first end of said second side section pivotably connected to said second end of said central section.

2. The support pillow as recited in claim 1, further comprising an adjustable tether having:
a first end attached to said second end of said first side section; and
a second end attached to said second end of said second side section,
wherein said adjustable tether is configured to hold said first side section and said second side section at a desired angled position relative to said central section.

3. The support pillow as recited in claim 2, wherein said adjustable tether further comprises two portions which are tied together to a length which holds said first side section and said second side section at said desired angle position.

4. The support pillow as recited in claim 2, wherein said adjustable tether further comprises an adjuster configured to allow adjustment of said tether in order to hold said first side section and said second side section at said desired angle position.

5. The support pillow as recited in claim 4, wherein said adjuster comprises a frictional connector.

6. The support pillow as recited in claim 1, wherein said central section comprises a central exterior covering constructed to form a central internal cavity, wherein said central internal cavity is filled with a compressible pillow material.

7. The support pillow as recited in claim 6,
wherein said first side section comprises a first exterior covering constructed to form a first internal cavity, wherein said first internal cavity is filled with said compressible pillow material, and
wherein said second side section comprises a second exterior covering constructed to form a second internal cavity, wherein said second internal cavity is filled with said compressible pillow material.

8. The support pillow as recited in claim 7, wherein said compressible pillow material comprises memory foam.

9. The support pillow as recited in claim 8, wherein said memory foam comprises gel-infused memory foam.

10. The support pillow as recited in claim 7, wherein said central exterior covering, said first exterior covering, and said second exterior covering comprise cotton.

11. The support pillow as recited in claim 10, wherein said support pillow is constructed to be machine washable.

12. The support pillow as recited in claim 7, wherein said central exterior covering, said first exterior covering, and said second exterior covering comprise an air-impermeable material.

13. The support pillow as recited in claim 12, wherein said compressible pillow material comprises air.

14. The support pillow as recited in claim 1, wherein said central section comprises a substantially circular cross section.

15. The support pillow as recited in claim 1, wherein said central section comprises a substantially oval cross section.

16. A support pillow, comprising:
a central section, comprising:
a first end,
a second end,
a cross section having a shape selected from the group consisting of circular and oval,
a central section height,
an internal filling, and
a covering around said internal filling;
a first side section, comprising:
a first end pivotably attached to said first end of said central section,
a second end,
a first side section height,
an internal filling, and
a covering around said internal filling;
a second side section, comprising:
a first end pivotably attached to said second end of said central section,
a second side section height,
an internal filling, and
a covering around said internal filling; and
a tether, comprising:
a cord having a first end attached to said second end of said first side section and a second end, and
an adjuster connected to said second end of said second side section,
wherein said second end of said cord is passed through said adjuster,
wherein said adjuster is configured to hold said cord at a desired position, causing said first section and said second section to remain at a desired angle position with respect to said central section,
wherein said first section height is equal to said second section height, and
wherein said central section height is less than said first section height.

17. The support pillow as recited in claim 16, wherein said adjuster comprises a friction connector.

18. The support pillow as recited in claim 16, wherein said covering of said central section, said covering of said first section, and said covering of said second section comprise a fabric made of cotton.

19. The support pillow as recited in claim 16, wherein said internal filling of said central section, said internal filling of said first section, and said internal filling of said second section comprise memory foam.

20. The support pillow as recited in claim 16, wherein said internal filling of said central section, said internal filling of said first section, and said internal filling of said second section comprise conventional pillow stuffing.
